(19) United States
(12) Patent Application Publication
(10) Pub. No.: US 2004/0230419 A1
(43) Pub. Date: Nov. 18, 2004

(54) DRAM access for MDCT/IDMCT implementation

(75) Inventors: Christos Chrysafis, Mountain View, CA (US); Siu-Leong Yu, San Jose, CA (US); Charlie Cheng, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Divio, Inc., Sunnyvale, CA

(21) Appl. No.: 10/439,613

(22) Filed: May 15, 2003

(51) Int. Cl. G10L 19/00

(52) U.S. Cl. 704/201

(57) ABSTRACT

To encode an audio signal xn, N samples of the audio signal is taken during each period of the signal (i.e., n varies from 0 to N-1) and are stored in a memory, such as a DRAM. The indices of the input samples (i.e., coefficients) are divided into T groups such that M of these coefficients each associated with a different one of the indices of each of the T groups may be read from the DRAM in a burst read operation. The M coefficients read during each burst operation are stored in a second memory in a burst write operation. Thereafter, each T time-domain coefficients whose indices belong to the same group are used to compute a first set of complex numbers ƒₛ which are subsequently used to encode the signal. Because the read and write operations are carried out using burst modes, the number of memory accesses is reduced, thereby improving efficiency and reducing cost.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to processing of digital audio signals, and more specifically to an improved method for storing and retrieving of digital audio signals from a memory.

Many different audio compression techniques have been developed to enable effective transmission and storage of digital audio signals. For example, when real-time signal processing is required, such as video conferencing over a computer network, audio and video signals are often compressed before they are transmitted.

In the encoding end of a typical audio compression system, analog audio signals are first converted to digital signals. The digital audio signals are then transformed from time-domain into frequency domain. Thereafter, the transformed coefficients associated with the frequency domain audio signals are quantized. The quantize values may be output, stored, transmitted. To decode the audio signal, the reverse of the above steps are performed, as known to those skilled in the art.

One method that achieves relatively high quality compression/decompression involves transform coding. Transform coding typically includes transforming a frame of an input audio signal into a set of transform coefficients, using a transform, such Discrete Cosine Transform (DCT), Modified Discrete Cosine Transform (MDCT), and Fourier Transform (FT), etc. Next, a subset of the transform coefficients, which typically represents a large portion of the energy of the input audio signal, is quantized and encoded using any one of a number of well-known coding techniques. Transform compression techniques, such as MDCT, generally provide a relatively high quality synthesized signal, since a relatively high number of spectral coefficients of an input audio signal are taken into consideration. Both MDCT and inverse modified discrete cosine transform (IMDCT) may be performed using a Fast Fourier Transform algorithm.

Determining spectral coefficients associated with MDCT and IMDCT using a FFT often requires computing the FFT coefficients, as well as reading and writing associated data in a memory, such as a Dynamic Random Access Memory (DRAM). Following is a description of implementing MDCT and IMDCT using a FFT.

Assume xₙ and Xₖ represent an input sample of an audio signal in the time domain and frequency domain (i.e., MDCT coefficient) respectively. MDCT coefficient Xₓ is computed from its corresponding time-domain signal xₙ using the following equation:

$${X}_{k} = 2 {\sum }_{n = 0}^{N - 1} {x}_{n} cos [ \frac{2 π}{N} ( n + {n}_{0} ) ( k + \frac{1}{2} ) ] \qquad ( 1 )$$

where N represents the number of samples taken in each period of the periodic signal xₙ, with 0<n<N and 0≦k<N/2, and n₀=(N/2+1)/2. During decoding, time-domain samples yₙ are reconstructed using the inverse of the MDCT, i.e., IMDCT, using the following equation:

$${y}_{n} = \frac{2}{N} {\sum }_{k = 0}^{N / 2 - 1} {X}_{k} cos [ \frac{2 π}{N} ( n + {n}_{0} ) ( k + \frac{1}{2} ) ] \qquad ( 2 )$$

FIG. 1 shows an MDCT logic block 10 that transforms time-domain signals xₙ to frequency-domain signals Xₖ, and an IDMCT logic block 12 that transforms frequency-domain signals Xₖ to time-domain signal yₙ.

From equation (2), it is seen that decoded time-domain samples yₙ have the following symmetrical and anti-symmetrical properties.

$$\begin{matrix}{y}_{\frac{3 N}{4} + 2 n} = {y}_{\frac{3 N}{4} - 1 - 2 n} & ( 3 ) \\ {y}_{\frac{N}{4} - 1 - 2 n} = - {y}_{2 n + \frac{N}{4}} & ( 4 )\end{matrix}$$

if 0≦n<N/8, and

$$\begin{matrix}{y}_{\frac{3 N}{4} - 2 n - 1} = - {y}_{2 n - \frac{N}{4}} & ( 5 ) \\ {y}_{\frac{5 N}{4} - 1 - 2 n} = {y}_{2 n + \frac{N}{4}} & ( 6 )\end{matrix}$$

if N/8≦n<N/4.

To compute the MDCT and IMDCT coefficients when 0≦n <N/4, using an FFT, three complex sequences ƒₙ, ξₙ and Uₖ are first defined, as shown below:

$$\begin{matrix}{f}_{n} = \{ \begin{matrix}( {x}_{\frac{3 N}{4} + 2 n} + {x}_{\frac{3 N}{4} - 1 - 2 n} ) + j ( {x}_{2 n + \frac{N}{4}} - {x}_{\frac{N}{4} - 1 - 2 n} ) & for & 0 \leq n < N / 8 \\ ( {x}_{\frac{3 N}{4} - 1 - 2 n} - {x}_{2 n - \frac{N}{4}} ) + j ( {x}_{\frac{N}{4} + 2 n} + {x}_{\frac{5 N}{4} - 1 - 2 n} ) & for & N / 8 \leq n < N / 4\end{matrix} & ( 7 ) \\ {ξ}_{n} = {W}_{N}^{n + \frac{1}{8}} {f}_{n} & ( 8 ) \\ {U}_{k} = {X}_{2 k} - j {X}_{\frac{N}{2} - 2 k - 1} & ( 9 )\end{matrix}$$

where j=\sqrt{−1}, Wₙ^{N}=e^{-(2 πj/N)n}, and 0≦k<N/4.

It can be shown that:

$$\frac{{U}_{k}}{2} = - {W}_{8 N}^{1} {W}_{N}^{k} {FFT}_{\frac{N}{4}} \{ {ξ}_{n} \} \qquad ( 10 )$$

where FFT_{N}{ξₙ} represents the N-point FFT of ξₙ.

Therefore, to compute MDCT coefficients Xₖ of the input samples xₙ using N/4-point FFT, the following steps are performed:

1) form complex sequence ƒₙ from xₙ as shown in equation (7);

2) form complex sequence ξₙₙ by multiplying complex sequence ƒₙ with

$${W}_{N}^{n + \frac{1}{8}} ,$$

as shown in equation (8)

3) Take the N/4-point FFT of ξₙ;

4) Multiply the FFT coefficients by W_{8N}¹W_{N}^{k} to form Uₖ, as shown in equation (10);

5) compute Xₖ from the real and imaginary parts of Uₖ, as shown in equation (9).

To compute the IMDCT coefficients, steps opposite to those shown above may be taken. As seen from equation (7), because of the uniqueness of Xₖ, time-domain samples yₙ of IMDCT also satisfy equation (7):

$${f}_{n} = \{ \begin{matrix}( {y}_{\frac{3 N}{4} + 2 n} + {y}_{\frac{3 N}{4} - 1 - 2 n} ) + j ( {y}_{2 n + \frac{N}{4}} - {y}_{\frac{N}{4} - 1 - 2 n} ) & for & 0 \leq n < N / 8 \\ ( {y}_{\frac{3 N}{4} - 1 - 2 n} - {y}_{2 n - \frac{N}{4}} ) + j ( {y}_{\frac{N}{4} + 2 n} + {y}_{\frac{5 N}{4} - 1 - 2 n} ) & for & N / 8 \leq n < N / 4\end{matrix} \qquad ( 11 )$$

By using the symmetrical and anti-symmetrical properties shown in equations (3-6), yₙ may be found from ƒₙ for 0≦n<N/8, as shown below:

$$\begin{matrix}{y}_{\frac{3 N}{4} + 2 n} = {y}_{\frac{3 N}{4} - 2 n - 1} = real ( {f}_{n} ) / 2 & ( 12 ) \\ {y}_{2 n + \frac{N}{4}} = - {y}_{\frac{N}{4} - 2 n - 1} = imag ( {f}_{n} ) / 2 & ( 13 ) \\ {y}_{\frac{N}{2} - 2 n - 1} = - {y}_{2 n} = real ( {f}_{n + \frac{N}{8}} ) / 2 & ( 14 ) \\ {y}_{N - 2 n - 1} = {y}_{\frac{N}{2} + 2 n} = imag ( {f}_{n + \frac{N}{8}} ) / 2 & ( 15 )\end{matrix}$$

where real(ƒ) and imag(ƒ) denote the real and imaginary parts of complex number ƒ.

Therefore, to compute IMDCT coefficients yₙ using N/4-point FFT, the following steps are performed:

1) form the complex sequence Uₖ from Xₖ, as shown in equation (9);

2) Form another complex sequence

$${V}_{k} = {FFT}_{\frac{N}{4}} \{ {ξ}_{k} \}$$

by multiplying Uₖ with W_{8N}⁻¹in equation (10);

3) compute ξₙ by taking the inverse N/4-point FFT of Vₖ;

4) compute ƒₙ by multiplying ξₙ with

$${W}_{N}^{- ( n + \frac{1}{8} )} ,$$

as shown in equation (8); 5) compute yₙ by taking the real and imaginary parts of ƒₙ, as shown in equations (12)-(15).

In conventional systems, to compute, for example, the MDCT coefficients using the five steps described above, data is read from or written into an associated DRAM one sample at a time. Since there is an overhead associated with each DRAM access, such systems may suffer from degraded data traffic in the DRAM bus, lower clock rate and relatively higher power consumption. Furthermore, as seen from step 1 associated with computing MDCT coefficients, N memory read operations (i.e., 4×N/8×2) are required to read different values of xₙ to form the sequence ƒₙ, and N/2 (i.e., 2×N/4) memory writes operations are required to write the results back to DRAM. Similarly, N/2 memory read operations and N/2 memory write operations are required to perform step 2 associated with computing MDCT coefficients. As described above, such high number of read and write operations lower system performance while increasing its cost.

Accordingly, there is a need to reduce the number of accesses made to a memory when computing the MDCT and IMDCT coefficients.

### BRIEF SUMMARY OF THE INVENTION

In accordance with the present invention, to encode an audio signal xₙ, N samples xₙ (n varies from 0 to N-1) of the audio signal are taken during each period and are stored in a memory, such as a DRAM. The indices of the input samples (i.e., coefficients) are divided into T groups such that M of these coefficients, each associated with a different one of the indices of each of the T groups, may be read from the DRAM in a burst read operation. The M coefficients read during each burst operation are stored in a second memory in a burst write operation. Thereafter, each T time-domain coefficients whose indices belong to the same group are used to compute a first set of complex numbers ƒₛ which are subsequently used to encode the signal.

In some embodiments, M is less than or equal to N and T is equal to four. In these embodiments, each pair of complex numbers is related to four time-domain coefficients in accordance with the following expression:

$$( {x}_{\frac{3 N}{4} + s} + {x}_{\frac{3 N}{4} - s - 1} ) + j ( {x}_{\frac{N}{4} + s} - {x}_{\frac{N}{4} - s - 1} ) = \{ \begin{matrix}{f}_{\frac{s}{2}} & n is even \\ j {f}_{( \frac{N}{4} - \frac{s + 1}{2} )}^{*} & for n is odd\end{matrix} \qquad ( 23 )$$

where s has a different value depending on whether n is even or odd.

Because, in accordance with the present invention, indices

$$( \frac{3 N}{4} + s ) , ( \frac{3 N}{4} - s - 1 ) ( \frac{N}{4} + s ) ( \frac{N}{4} - s - 1 )$$

are in sequential order in terms of s, transfer of coefficients xₙ from the DRAM to the second memory (e.g., SRAM) is carried out using burst read/write operation, thereby reducing the number of accesses to the DRAM and thus reducing cost.

The encoded coefficients are computed by taking real and imaginary parts of Uₖ, defined by:

$$\frac{{U}_{k}}{2} = - ( {W}_{8 N}^{1} {W}_{N}^{k} ) {FFT}_{\frac{N}{4}} [ {ξ}_{n} ]$$

wherein FFT

$$\frac{N}{4}$$

[ξₙ] represents a Fast-Fourier Transform of the N/4 point of complex number ξₛ, which is computed by multiplying the first complex number ƒₛ with the associated second constant

$${W}_{N}^{s + \frac{1}{8}} ,$$

and wherein W_{8N}¹ and W_{N}^{k} are constants. Uₖ and FFT of the N/4 point of complex numbers ξₛ are stored in the DRAM during a burst write burst operation. Moreover, Uₖ are read during a burst operation from the DRAM to extract real and imaginary parts thereof.

### BRIEF DESCRIPTION OF THE DRAWINGS

FIG. 1 is a simplified high-level block diagram of an encoder and a decoder, as known in the prior art.

FIG. 2 shows coefficient indices that are reordered, in accordance with the present invention, to enable burst read and write operations thereof.

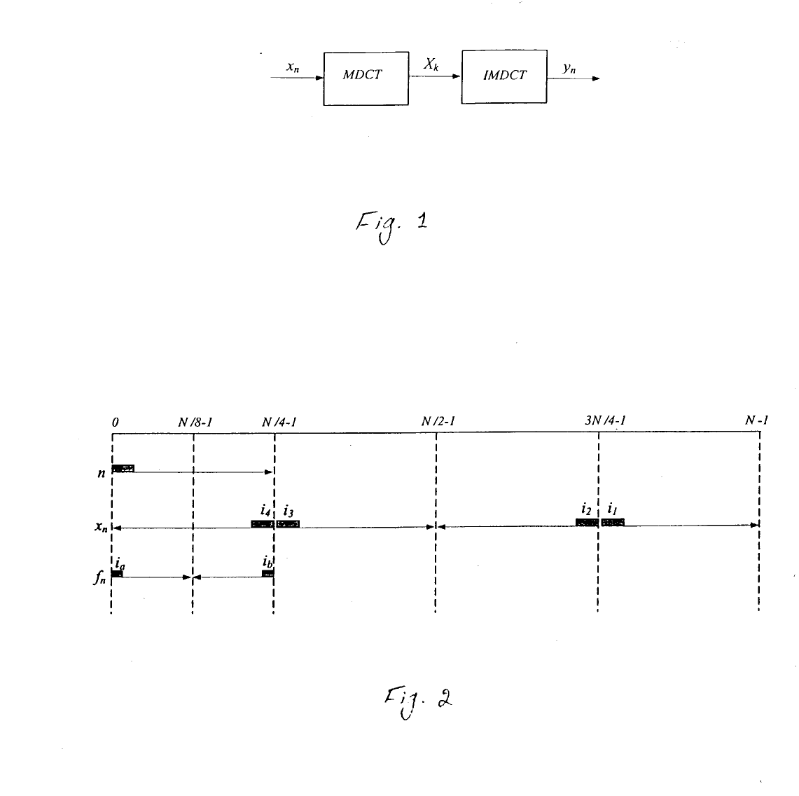

### DETAILED DESCRIPTION OF THE INVENTION

In accordance with the present invention, the indices of input samples of an audio signal and other associated signals are rearranged so as to be in order, thereby enabling these signals to be stored in and read from a DRAM using a burst mode and thus limiting the number of accesses made to the DRAM. Moreover, some of the mathematical steps involved in computing the MDCT and IMDCT coefficients are combined so as to further reduce the number of accesses made to the DRAM.

As seen from equation (7) above, the indices of input samples xₙ are not in sequential order, and thus these input samples are not adapted to be stored or retrieved from a memory using a burst mode of operation. In accordance with one aspect of the present invention, the indices of input samples xₙ are rearranged so as to be in sequence to enable the storage and retrieval of these input samples from a memory, e.g., a DRAM, using a burst mode. The rearranging of these indices is described below.

For the case of 0≦n<N/8 in equation (7), new parameter m is defined as being equal to 2n (m=2n). After replacing n with m for this condition in equation (7), the following equation (16) is obtained:

$${f}_{m / 2} = ( {x}_{\frac{3 N}{4} + m} + {x}_{\frac{3 N}{4} - m - 1} ) + j ( {x}_{\frac{N}{4} + m} - {x}_{\frac{N}{4} - m - 1} ) \\ for 0 \leq m < N / 4 and m is even number . \qquad ( 16 )$$

For the case of N/8≦n<N/4 in equation (7), parameters m₁ and n₁ are defined as following:

n₁=N/4−n−1

m₁=2n₁+1.

Therefore,

0≦n₁<N/8 and,

0≦m₁<N/4. Furthermore, because m₁ is equal to 2n₁ +1; m₁ is an odd number with

n=N/4−(m₁+1)/2 (17)

The indices of the terms used in condition N/8≦n<N/4 of equation (7) are thus rearranged as:

3N/4−2n−1=N/4+2n₁+1=N/4+m₁ (18)

2n−N/4=N/4−2n₁−2=N/4−m₁−1 (19)

N/4+2n=3N/4−2n₁−2=3N/4=m₁ (20)

5N/4−2n−1=3N/4+2n₁+1=3N/4+m₁ (21)

Using these indices and multiplying the conjugated ƒₙ of with j, the expression for ƒₙ for the condition N/8≦n<N/4 of equation (7) is rewritten as:

$$j {f}_{( \frac{N}{4} - \frac{{m}_{1} + 1}{2} )}^{*} = ( {x}_{\frac{3 N}{4} + {m}_{1}} + {x}_{\frac{3 N}{4} - {m}_{1} - 1} ) + j ( {x}_{\frac{N}{4} + {m}_{1}} - {x}_{\frac{N}{4} - {m}_{1} - 1} ) \\ for 0 \leq {m}_{1} < N / 4 and {m}_{1} is odd number . \qquad ( 22 )$$

Comparing the left hand sides of equations (16) and (22), it is seen that:

$$( {x}_{\frac{3 N}{4} + s} + {x}_{\frac{3 N}{4} - s - 1} ) + j ( {x}_{\frac{N}{4} + s} - {x}_{\frac{N}{4} - s - 1} ) = \{ \begin{matrix}{f}_{\frac{s}{2}} & n is even \\ j {f}_{( \frac{N}{4} - \frac{s + 1}{2} )}^{*} & for n is odd\end{matrix} \qquad ( 23 )$$

where s=m if n is even and s=m₁ if n is odd.

The indices of various terms in equation (23) may be represented as shown below:

t₁=3N/4+s (24)

i₂=3N/4−s−1 (25)

i₃=N/4+s (26)

i₄=N/4−s−1 (27)

iₐ=s/2 (28)

i_{b}=N/4−(s+1)/2 (29)

FIG. 2 shows the above indices which are in sequential order in terms of s to enable burst read and write operations.

Because, in accordance with the present invention, indices i₁, i₂, i₃, i₄, iₐ, and i_{b} are in sequential order in terms of s, transfer of coefficients xₙ from the DRAM to the local memory (e.g., SRAM) is carried out using burst read/write operation, thereby reducing the number of accesses to the DRAM and thus reducing cost, as is explained further below.

Time-domain input sample coefficients xₙ are stored in the DRAM as they are received from, e.g., an analog-to-digital converter (not shown). These sample coefficients xₙ are used to compute corresponding frequency-domain coefficients Xₖ. As is seen from equations (23) and (8)-(10) above, computation of each frequency-domain coefficient Xₖ requires four time-domain coefficient xₙ whose indices are in sequential order (i.e., in order), as is seen from equation (23). Therefore, time-domain coefficients associated with computing each frequency-domain coefficient Xₖ are read from the DRAM using a burst read operation and transferred to the local RAM using a burst write operation. Because s varies from zero to (N-1) there are N such burst read/write operations. In other words, during each of the N burst read/write operations, four time-domain coefficients having indices i₁, i₂, i₃, i₄, are transferred from the DRAM to the SRAM (i.e., burst write from the DRAM and burst read to the SRAM). The four time-domain coefficients transferred during each read/write burst operations are used to compute values of ƒₙ and Uₖ, which in turn are used to compute values of MDCT coefficients Xₖ, in accordance with equations (23) and (8)-(10).

The reduction in the number of DRAM accesses depends on the number of bytes that the DRAM is adapted to provide during a read burst operation and the size of the local memory in which the xₙ values are stored after being read from the DRAM. If the DRAM is adapted to supply M number of coefficients (i.e., the number of xₙ coefficients) during each read burst cycle as the indices are rearranged to be in sequence, the number of DRAM read accesses is reduced by a factor of M. If Nᵣ is the number of bytes that the DRAM is adapted to provide during a read burst operation and m is the number of bytes associated with each coefficient, then Nᵣ=mMᵣ. Accordingly, a total of 4 mM bytes is required to store the xₙ values in the local memory. Similarly, as seen from equations 23-29, in accordance with the present invention, the number of write operations required to store values of ƒₙ to DRAM is also reduced by a factor of M. Accordingly, a total of 2 mM bytes is required to store the values of

$${f}_{\frac{n}{2}} and {f}_{( \frac{N}{4} - \frac{n + 1}{2} )}^{*}$$

in the local memory.

Moreover because the indices of the various coefficients in equation (9) and (10) which in combination perform the following operations: (1) taking the N/4-point FFT of ξₙ: (2) multiplying the FFT coefficients by W_{8N}¹W_{N}^{k} to form Uₖ; and (3) computing Xₖ from the real and imaginary parts of Uₖ, appear in sequence, to further reduce the number of DRAM accesses, these coefficients are also read from the DRAM using burst read operations.

As described above, combined equations (7) and (8) above perform the following operations: (1) form complex sequence ƒₙ from xₙ; and (2) form complex sequence ξₙₙ by multiplying complex sequence ƒₙ with

$${W}_{N}^{n + \frac{1}{8}} .$$

Using conventional prior art techniques, during step (1) N memory read operations (i.e., 4×N/8×2) are required to read the values of xₙ and to form the ƒₙ values. Furthermore, N/2 memory write operations (2×N/4) are required to write the ƒₙ values to DRAM. Similarly, during step (2) N/2 memory read operations and N/2 memory writes operations are required. In other words, in the prior art, the combined steps (1) and (2) require 3N/2 memory read operations and N memory write operations.

In accordance with the present invention, to further reduce the number of DRAM accesses, the values of ƒₙ are not written to the DRAM. Instead the ƒₙ values are multiplied by W_{N} to compute the values of ξₙ, which are subsequently stored in the DRAM. Therefore, in accordance with the present invention, N read operations and N/2 write operations are required. Because coefficients W_{N}ⁿ have constants values they may be stored in a local Read Only Memory (ROM).

The same principles described above and which enable time-domain coefficients to be read from the DRAM using burst read modes are also applied to computing the IMDCT to reduce the total number of DRAM accesses. It can be shown that

$$( {y}_{\frac{3 N}{4} + s} + {y}_{\frac{3 N}{4} - s - 1} ) + j ( {y}_{\frac{N}{4} + s} - {y}_{\frac{N}{4} - s - 1} ) = \{ \begin{matrix}{f}_{\frac{s}{2}} & for n is even \\ j {f}_{( \frac{N}{4} - \frac{s + 1}{2} )}^{*} & for n is odd\end{matrix} \qquad ( 30 )$$

where s=m if n is even and s=m₁ if n is odd.

By using the symmetrical and anti-symmetrical property of yₙ shown in equations (3)-(6), the following are obtained is n is even:

$$\begin{matrix}{y}_{\frac{3 N}{4} + s} = {y}_{\frac{3 N}{4} - s - 1} = real ( {f}_{s / 2} ) / 2 & ( 31 ) \\ {y}_{s + \frac{N}{4}} = - {y}_{\frac{N}{4} - s - 1} = imag ( {f}_{s / 2} ) / 2 & ( 32 )\end{matrix}$$

And the following are obtained if n is odd:

$$\begin{matrix}{y}_{\frac{3 N}{4} + s} = {y}_{\frac{3 N}{4} - s - 1} = real ( j {f}_{( \frac{N}{4} - \frac{s + 1}{2} )}^{*} ) / 2 & ( 33 ) \\ {y}_{s + \frac{N}{4}} = - {y}_{\frac{N}{4} - s - 1} = imag ( j {f}_{( \frac{N}{4} - \frac{s + 1}{2} )}^{*} ) / 2 & ( 34 )\end{matrix}$$

As seen from equations (31)-(33), the indices of coefficients yₙ and ƒₙ are the same as those of i₁, i₂, i₃, i₄, iₐ, and i_{b} defined above in equations (25)-(29). Because indices i₁, i₂, i₃, i₄, iₐ, and i_{b} are in sequential order in terms of s, transfer of coefficients to the DRAM is carried out using burst write operation, thereby reducing the number of accesses to the DRAM and thus further reducing the cost.

The indices described above in connection with equations (24)-(29) are applicable to writing of yₙ values to the DRAM and to the reading of ƒₙ values from the DRAM. Therefore, because the DRAM is adapted to write M number of coefficients (i.e., the number of yₙ coefficients) during each write burst cycle as the indices are rearranged to be in sequence, the number of DRAM write accesses is reduced by a factor of M. Since the MDCT and IMDCT do not occur concurrently, the same local memory may be used during the MDCT and IMDCT.

Moreover because the indices of the various coefficients involved in computing IMDCT coefficients (i.e., yₙ) from Xₖ discussed above and repeated again below: (1) forming the complex sequence Uₖ from Xₖ, as shown in equation (9) above; (2) forming complex sequence

$${V}_{k} = {FFT}_{\frac{N}{4}} \{ {ξ}_{k} \}$$

by multiplying Uₖ with W_{8N}⁻¹W_{N}^{-k}, as shown in equation (10) above, and (3) computing ξₙ by taking the inverse N/4-point FFT of Vₖ, appear in series, reading and writing of the associated values in the DRAM may also be performed using burst read and write operations, respectively.

As described above, in computing the IMDCT coefficients, ƒₙ values are obtained by multiplying ξₙ with

$${W}_{N}^{- ( n + \frac{1}{8} )} ,$$

as shown in equation (8). Subsequently, yₙ values are computed by taking the real and imaginary parts of ƒₙ, as shown in equations (31)-(34). Using conventional prior art techniques, the above computations require 3N/2 memory read operations and N memory write operations.

In accordance with the present invention, to further reduce the number of DRAM accesses, the values of ξₙ are not written to the DRAM. Instead the ξₙ values are multiplied by

$${W}_{N}^{- ( n + \frac{1}{8} )}$$

to compute the values of ƒₙ, which are subsequently stored in the DRAM. Therefore, in accordance with the present invention, N read operations and N/2 write operations are required.

It is understood that the above embodiments of the present invention may be performed entirely by software modules executed by a central processing unit. The above embodiments may also be performed by a combination of software and hardware modules. Alternatively, other embodiments may be performed entirely by dedicated hardware modules.

The above embodiments of the present invention are illustrative and not limitative. Various alternatives and equivalents are possible. The invention is not limited by the type of memory used to store and read the coefficients. Nor is the invention limited by the size of the burst operation that a memory is adapted to support. The invention is not limited by the encoding or decoding of the input signals. Nor is the invention limited by the method used to transform time-domain values to frequency-domain values. Other additions, subtractions, deletions, and other modifications and changes to the present invention may be made thereto without departing from the scope of the present invention and is set forth in the appended claims.

What is claimed is:

1. A method for encoding and decoding of audio signals, the method comprising:
receiving N time-domain coefficients each having an associated index n ranging from 0 to N-1, said N time-domain coefficients adapted to be encoded;
storing the N time-domain coefficients in a first memory;
forming T groups of indices each defined by index n and N;
reading M coefficients each associated with a different one of the indices of each of the T groups from the first memory using a burst read operation;
storing each of the read M coefficients each associated with a different one of the indices of each of the T groups in a second memory using a burst write operation; and
computing a first plurality of first complex numbers, each of the first plurality of first complex numbers defined by T time-domain coefficients each having an index selected from a corresponding one of the M indices associated with that group.

2. The method of claim 1 wherein M is less than or equal to N and T is equal to four.

3. The method of claim 2 further comprising:
multiplying each of the first complex numbers by an associated second complex number to generate a plurality of third complex numbers.

4. The method of claim 3 further comprising:
storing the plurality of the third complex numbers in a second memory using a burst write operation.

5. The method of claim 4 further comprising:
reading the plurality of the third complex numbers from the second memory using a burst read operation;
transforming the plurality of the third complex numbers read from the second memory from time domain to frequency domain;
multiplying each of the plurality of frequency domain numbers by a different fourth complex number to generate a plurality of fifth complex numbers; extracting real and imaginary parts of each of the fifth complex numbers, wherein the real and imaginary parts of the fifth complex numbers represent encoded data.

6. The method of claim 5 wherein indices i₁, i₂, i₃, i₄ in each of the T groups are respectively
$$( \frac{3 N}{4} + s ) , ( \frac{3 N}{4} - s - 1 ) ( \frac{N}{4} + s ) ( \frac{N}{4} - s - 1 ) ,$$
if s in an even number, wherein N is the number of samples in each period, and wherein
$${f}_{\frac{s}{2}}$$
is defined by:
$$( {x}_{\frac{3 N}{4} + s} + {x}_{\frac{3 N}{4} - s - 1} ) + j ( {x}_{\frac{N}{4} + n} + {x}_{\frac{N}{4} - n - 1} ) ,$$
and wherein xᵢ₁, xᵢ₂, xᵢ₃, xᵢ₄ represent the time-domain coefficients in that T group, and wherein
$${f}_{\frac{s}{2}}$$
form a first portion of the first plurality of complex numbers.

7. The method of claim 6 wherein a second portion of the first plurality of complex numbers
$$j {f}^{*} \frac{N}{4} - \frac{s + 1}{2}$$
is defined by
$$( {x}_{\frac{3 N}{4} + s} + {x}_{\frac{3 N}{4} - s - 1} ) + j ( {x}_{\frac{N}{4} + n} - {x}_{\frac{N}{4} - n - 1} ) ,$$
if s in an odd number.

8. The method of claim 7 wherein the third plurality of complex numbers ξₛ are computed by multiplying the first plurality of complex numbers ƒₛ with the third plurality of complex numbers
$${W}_{N}^{s + \frac{1}{8}}$$
each of which is a complex constant number.

9. The method of claim 8 wherein the fifth complex number
$$\frac{{U}_{k}}{2}$$
with the k-th index is defined by:
$$\frac{{U}_{k}}{2} = - ( {W}_{8 N}^{1} {W}_{N}^{k} ) {FFT}_{\frac{N}{4}} [ {ξ}_{n} ]$$
wherein
$${FFT}_{\frac{N}{4}} [ {ξ}_{n} ]$$
represents a Fast-Fourier Transform of the N/4 point of ξₛ and wherein W_{8N}¹and W_{N}^{k} are complex constants.

10. The method of claim 9 wherein said
$$\frac{{U}_{k}}{2}$$
is related to the frequency-domain signals of the digital signals by the following equation:
$$\frac{{U}_{k}}{2} = {X}_{2 k} - j {X}_{\frac{N}{2} - 2 k - 1}$$

11. The method of claim 10 further comprising:
storing the Fast-Fourier Transform of the N/4 point of a plurality of the third complex numbers ξₛ during a burst write operation in the first memory.

12. The method of claim 11 further comprising:
storing a plurality of the fifth complex numbers Uₖ during a burst write operation in the first memory.

13. The method of claim 12 further comprising:
reading a plurality of the fifth complex numbers Uₖ during a burst read burst operation from the second memory to extract real and imaginary parts thereof, wherein said real and imaginary parts of Uₖ represent encoded audio signals.

14. The method of claim 13 further comprising:
reading the first plurality of complex numbers from the first memory in a burst mode read operation to decode the encoded signal values; wherein each four decoded signal values y have indices i₁, i₂, i₃, i₄ is defined by:
$$( {y}_{\frac{3 N}{4} + s} + {y}_{\frac{3 N}{4} - s - 1} ) + j ( {y}_{\frac{N}{4} + s} - {y}_{\frac{N}{4} - s - 1} ) = \{ \begin{matrix}{f}_{\frac{s}{2}} & for n is even \\ j {f}_{( \frac{N}{4} - \frac{s + 1}{2} )}^{*} & for n is odd\end{matrix} \\ wherein \\ {y}_{\frac{3 N}{4} + s} = {y}_{\frac{3 N}{4} - s - 1} = real ( {f}_{s / 2} ) / 2 and {y}_{s + \frac{N}{4}} = - {y}_{\frac{N}{4} - s - 1} = imag ( {f}_{s / 2} ) / 2$$
if s is an even number; and
$${y}_{\frac{3 N}{4} + s} = {y}_{\frac{3 N}{4} - s - 1} = real ( j {f}_{( \frac{N}{4} - \frac{s + 1}{2} )}^{*} ) / 2 and {y}_{s + \frac{N}{4}} \\ = - {y}_{\frac{N}{4} - s - 1} = imag ( j {f}_{( \frac{N}{4} - \frac{s + 1}{2} )}^{*} ) / 2$$
if s is an odd number.

15. The method of claim 14 wherein decoded signal values y are stored in the DRAM in a burst write operation.

16. An apparatus configured to encode and decode audio signals, the apparatus comprising:
a module configured to receive N time-domain coefficients each having an associated index n ranging from 0 to N-1, said N time-domain coefficients adapted to be encoded;
a module configured to store the N time-domain coefficients in a first memory;
a module configured to form T groups of indices each defined by index n and N;
a module configured to read M coefficients each associated with a different one of the indices of each of the T groups from the first memory using a burst read operation;
a module configured to store each of the read M coefficients each associated with a different one of the indices of each of the T groups in a second memory using a burst write operation; and
a module configured to compute a first plurality of first complex numbers, each of the first plurality of first complex numbers defined by T time-domain coefficients each having an index selected from a corresponding one of the M indices associated with that group.

17. The apparatus of claim 16 wherein M is less than or equal to N and T is equal to four.

18. The apparatus of claim 16 further comprising:
a module configured to multiply each of the first complex numbers by an associated second complex number to generate a plurality of third complex numbers.

19. The apparatus of claim 18 further comprising:
a module configured to store the plurality of the third complex numbers in a second memory using a burst write operation.

20. The apparatus of claim 19 further comprising:
a module configured to read the plurality of the third complex numbers from the second memory using a burst read operation;
a module configured to transform the plurality of the third complex numbers read from the second memory from time domain to frequency domain;
a module configured to multiply each of the plurality of frequency domain numbers by a different fourth complex number to generate a plurality of fifth complex numbers; extracting real and imaginary parts of each of the fifth complex numbers, wherein the real and imaginary parts of the fifth complex numbers represent encoded data.

21. The apparatus of claim 20 wherein indices i₁, i₂, i₃, i₄ in each of the T groups are respectively
$$( \frac{3 N}{4} + s ) , ( \frac{3 N}{4} - s - 1 ) ( \frac{N}{4} + s ) ( \frac{N}{4} - s - 1 ) ,$$
if s in an even number, wherein N is the number of samples in each period, and wherein
$${f}_{\frac{s}{2}}$$
is defined by:
$$( {x}_{\frac{3 N}{4} + s} + {x}_{\frac{3 N}{4} - s - 1} ) + j ( {x}_{\frac{N}{4} + n} - {x}_{\frac{N}{4} - n - 1} ) ,$$
and wherein Xᵢ₁, Xᵢ₂, Xᵢ₃, Xᵢ₄ represent the time-domain coefficients in that T group, and wherein
$${f}_{\frac{s}{2}}$$
form a first portion of the first plurality of complex numbers.

22. The apparatus of claim 21 wherein a second portion of the first plurality of complex numbers
$$j {f}^{*} \frac{N}{4} - \frac{s + 1}{2}$$
is defined by
$$( {x}_{\frac{3 N}{4} + s} + {x}_{\frac{3 N}{4} - s - 1} ) + j ( {x}_{\frac{N}{4} + n} - {x}_{\frac{N}{4} - n - 1} ) ,$$
if s in an odd number.

23. The apparatus of claim 22 wherein the third plurality of complex numbers ξₛ are computed by multiplying the first plurality of complex numbers ƒₛ with the third plurality of complex numbers
$${W}_{N}^{s + \frac{1}{8}}$$
each of which is a complex constant number.

24. The apparatus of claim 23 wherein the fifth complex number
$$\frac{{U}_{k}}{2}$$
with the k-th index is defined by:
$$\frac{{U}_{k}}{2} = - ( {W}_{8 N}^{1} {W}_{N}^{k} ) {FFT}_{\frac{N}{4}} [ {ξ}_{n} ]$$
wherein
$${FFT}_{\frac{N}{4}} [ {ξ}_{n} ]$$
represents a Fast-Fourier Transform of the N/4 point of ξₛ and wherein W_{8N}¹ and W_{N}^{k} are complex constants.

25. The apparatus of claim 24 herein said
$$\frac{{U}_{k}}{2}$$
is related to the frequency-domain signals of the digital signals by the following equation:
$$\frac{{U}_{k}}{2} = {X}_{2 k} - j {X}_{\frac{N}{2} - 2 k - 1}$$

26. The apparatus of claim 25 further comprising:
a module adapted to store the Fast-Fourier Transform of the N/4 point of a plurality of the third complex numbers ξₛ during a burst write operation in the first memory.

27. The apparatus of claim 26 further comprising:
a module adapted to store a plurality of the fifth complex numbers Uₖ during a burst write operation in the first memory.

28. The apparatus of claim 27 further comprising:
a module adapted to read a plurality of the fifth complex numbers Uₖ during a burst read burst operation from the second memory to extract real and imaginary parts thereof, wherein said real and imaginary parts of Uₖ represent encoded audio signals.

29. The apparatus of claim 28 further comprising:
a module adapted to read the first plurality of complex numbers from the first memory in a burst mode read operation to decode the encoded signal values; wherein each four decoded signal values y have indices i₁, i₂, i₃, i₄ is defined by:
$$\begin{matrix}( {y}_{\frac{3 N}{4} + s} + {y}_{\frac{3 N}{4} - s - 1} ) + j ( {y}_{\frac{N}{4} + s} - {y}_{\frac{N}{4} - s - 1} ) = \{ \begin{matrix}{f}_{\frac{s}{2}} & for n is even \\ j {f}_{( \frac{N}{4} - \frac{s + 1}{2} )}^{*} & for n is odd\end{matrix} \\ wherein \\ {y}_{\frac{3 N}{4} + s} = {y}_{\frac{3 N}{4} - s - 1} = real ( {f}_{s / 2} ) / 2 and {y}_{s + \frac{N}{4}} = - {y}_{\frac{N}{4} - s - 1} = imag ( {f}_{s / 2} ) / 2 \end{matrix}$$
if s is an even number; and
$${y}_{\frac{3 N}{4} + s} = {y}_{\frac{3 N}{4} - s - 1} = real ( j {f}_{( \frac{N}{4} - \frac{s + 1}{2} )}^{*} ) / 2 and {y}_{s + \frac{N}{4}} = - {y}_{\frac{N}{4} - s - 1} = imag ( j {f}_{( \frac{N}{4} - \frac{s + 1}{2} )}^{*} ) / 2$$
if s is an odd number.

30. The apparatus of claim 29 wherein decoded signal values y are stored in the DRAM in a burst write operation.
